(19) United States
(12) Patent Application Publication
(10) Pub. No.: US 2003/0154772 A1
(43) Pub. Date: Aug. 21, 2003

(54) Method and apparatus for viscosity measurement

(76) Inventor: Michael Jackson, Twyford Reading (GB)

Correspondence Address: Martin Fleit, Fleit Kain Gibbons Gutman & Bongini, Suite 404, 601 Brickell Key Drive, Miami, FL, 33131, US

(21) Appl. No.: 10/240,149

(22) PCT Filed: Mar. 30, 2001
(86) PCT No.: PCT/GB01/01469

(30) Foreign Application Priority Data
Mar. 31, 2000 (GB) 0007719.8

(51) Int. Cl. G01N 11/14

(52) U.S. Cl. 73/54.28

(57) ABSTRACT

The apparatus (20) comprises a substantially cylindrical rotatable body (26) disposed coaxially within a retaining means (28), drive means (22) for rotating the rotatable body, control means for controlling the speed of the rotatable body, current measurement means for measuring the electric current supplied to the drive means, and means for converting the current measurement into a viscosity measurement. The bore (32a) of the retaining means (28) is of a complementary shape to the rotatable body (26), and the bore (32a) and the rotatable body (26) are dimensioned and spaced apart radially so as to form an annular gap (40) extending axially therebetween to receive the liquid (18). The rotatable body has a spiralled groove formed thereon so that liquid may be more easily transported into the gap between the rotatable body and the retaining means, thereby facilitating the measurement of small liquid samples.

### TECHNICAL FIELD

The present invention relates to a method and an apparatus for viscosity measurement. It relates particularly, but not exclusively, to a method and an apparatus for the measurement of viscosity of small volumes of liquid.

### BACKGROUND ART

The measurement of viscosity of small samples of liquid (i.e., less than 1 millilitre) can be fairly difficult to carry out. Traditionally, measurements of small samples have been made with a cone-and-plate viscometer. Such a viscometer is shown in FIGS. 1a and 1b, and comprises a cone (10) which is inserted into a hollow cylindrical body (12) having a flat base (14) (otherwise known as a plate). The cylindrical body (12) and plate (14) form a sample cup (16) into which the sample (18) to be measured is placed. In order to measure the viscosity of the sample (18) the cone (10) is rotated while the sample cup (16) is kept stationary. The resistance of the sample (18) to the rotation of the cone (10) produces a torque which is proportional to the shear stress in the sample. This measurement of torque can easily be converted into a viscosity measurement. However, the cone-and-plate method requires that the liquid sample (18) is removed from its container and placed in the sample cup (16) for the measurements to be taken. In addition, cone-and plate viscometers usually only measure viscosities which are higher than 100 milliPascal seconds (mPas).

Another method of measuring the rheological characteristics of a fluid is described in U.S. Pat. No. 4,643,021 (Bertin & Cie). The method consists of applying a torque to a rotatable cylinder which is completely immersed in the fluid, and determining the viscosity of the fluid from the torque required to maintain the cylinder at a constant speed of rotation. The fluid is contained within a tube, and the tube is placed inside a constant temperature jacket. The cylinder is caused to rotate by an electromagnetic field produced by an induction winding which surrounds the jacket. The apparatus is very complex and does not lend itself for use in the analysis of samples in-situ.

Another method and apparatus for measuring viscosity is described in European Patent No. EP 233 923 B1 (Bread Research Institute of Australia). This method involves: introducing a fluid into a heatable chamber; adjusting the temperature of the fluid in the chamber; stirring the fluid by way of a stirrer which is rotated at a measured speed; measuring the power consumed by the rotating stirring means; and converting the measured power consumption into a measurement of viscosity of the fluid. However, the apparatus is fairly complex and is not suitable for measurement of very small volumes of liquid.

A further viscosity measurement apparatus is disclosed in U.S. Pat. No. 5,821,407 (Seliguchi et al). The apparatus includes a detachable rotor which is placed in a fluid sample, a motor for driving the rotor, and a viscosity detection head. The viscosity detection head contains a device for detecting the amount of torque applied to the rotor when it is rotated in the fluid, so that the viscosity of the fluid may be measured. The type of rotor used in the apparatus can be changed so that measurement of specimen liquids of different types can be carried out. For example, a rotor having a larger diameter can be used for low-viscosity liquids, and a rotor having a small diameter can be used for high-viscosity liquids. The system also contains a rotor cleaning unit which includes two cleaning pots: one containing water, the other containing a cleaning fluid. In order to clean the rotor(s), the rotor is placed in the cleaning pots. This system is fairly complex, and different sized rotors are needed for measuring the properties of different liquids.

An aim of the present invention is to provide a method and an apparatus for the measurement of viscosity of small volumes of liquid. Another aim of the invention is to enable measurement of the viscosity of a fluid to be made in situ.

### DISCLOSURE OF INVENTION

According to a first aspect of the invention there is provided an apparatus for measuring the viscosity of a fluid, the apparatus comprising: a substantially cylindrical rotatable body disposed coaxially within a retaining means, drive means for rotating the rotatable body, control means for controlling the speed of the rotatable body, current measurement means for measuring the electric current supplied to the drive means, and means for converting the current measurement into a viscosity measurement, characterised in that the bore of at least a portion of the retaining means is of a complementary shape to the rotatable body, and the bore and the rotatable body being dimensioned and spaced apart radially so as to form an annular gap extending axially therebetween to receive, in use, the fluid.

According to a second aspect of the invention there is provided a method of measuring the viscosity of a fluid, the method comprising the steps of: a) providing a substantially cylindrical rotatable body disposed coaxially within a retaining means, the bore of at least a portion of the retaining means being of a complementary shape to the rotatable body, and the bore and the rotatable body being dimensioned and spaced apart axially so as to form an annular gap extending axially therebetween; b) introducing the rotatable body into the fluid; c) rotating the rotatable body at a preselected speed, thereby causing fluid to flow into said gap and changing the speed of rotation of the rotatable body; and d) measuring the electric current required by the drive means in order to maintain the rotatable body rotating at the preselected speed of rotation, thereby to provide an indication of the viscosity of the fluid.

Preferably the rotatable body is in the shape of a right circular cylinder. Alternatively, the rotatable body may have tapered sides so that it is frusto-conical in shape. The rotatable body may be barrel shaped, or even have a corrugated profile in order to increase the surface area of the body. The rotatable body may have a spiralled groove formed therein so that fluid may be more easily transported into the gap between the rotatable body and the retaining means. This type of rotatable body will be of use if the fluid is highly viscous.

Preferably the retaining means is a tubular jacket. Most preferably the tubular jacket has a stepped profile so that it comprises a first jacket portion and a second jacket portion, the second jacket portion having a smaller diameter than the first jacket portion. Preferably the first jacket portion is dimensioned so that it is an interference fit with the rotation means. Preferably the retaining means has at least one vent formed therein. This vent enables air displaced by the fluid in the gap to escape from the gap. The vent may also permit the flow of the fluid under test therethrough.

The retaining means and/or the rotatable body may be made of an alloy (such as an alloy of aluminium), a metal, a plastics material, or any other suitable material.

The apparatus may also include display means for displaying, for example, the viscosity of a fluid under test, the speed of rotation of the rotatable body, and the temperature of the fluid.

The apparatus may also further include a cleaning means for cleaning the apparatus, the cleaning means including at least one nozzle connected to the apparatus via the vent(s) through which a cleaning fluid may be introduced. The apparatus may therefore be cleaned in situ. The nozzle(s) may be detachable, or may be formed as an integral part of the retaining means.

The apparatus preferably also includes temperature measurement means for measuring the temperature of the fluid under test. The temperature measurement means may be a thermocouple probe, a platinum resistance heater, or another suitable temperature measurement element. The thermocouple is preferably positioned so that it is in contact with the fluid being tested. The positioning of the temperature measurement means depends on the material from which the parts of the apparatus are made, i.e., whether or not the parts are good conductors of heat.

The apparatus may also contain moving means so that the rotatable body can be moved up and down thereby changing the volume of the gap between the rotatable body and the retaining means.

### BRIEF DESCRIPTION OF DRAWINGS

An number of embodiments of the invention will now be described, by way of example only, with reference to the accompanying Figures, in which:-

FIG. 1a shows an isometric view of a cone-and-plate viscometer (prior art);

FIG. 1b shows a cross-sectional view of part of the viscometer shown in FIG. 1a;

FIG. 2 shows a diagrammatical cross-section of the viscosity measurement apparatus;

FIG. 3 shows an engineering drawing of part of the viscosity measurement apparatus;

FIG. 4 shows a diagrammatical cross-sectional view of part of the viscosity measurement apparatus;

FIG. 5 shows a graph of applied current against viscosity for various motors;

FIG. 6 shows a circuit diagram of the electronic circuits used in the apparatus;

FIG. 7 shows a graph of applied current against cylinder separation for a various viscosities;

FIG. 8 shows a diagrammatical cross-sectional view of a rifled bob;

FIG. 9 shows a diagrammatical cross-sectional view of the cleaning mechanism of the apparatus; and

FIG. 10 shows a diagrammatical cross-sectional view of the apparatus having a bob with tapered sides.

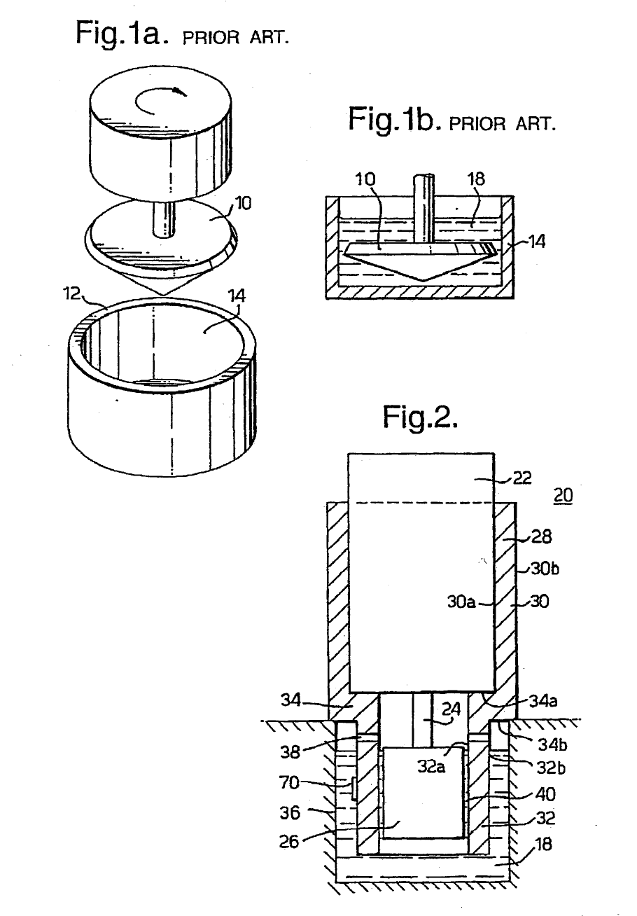

### DETAILED DESCRIPTION OF PREFERRED EMBODIMENTS

FIG. 2 shows a schematic cross-sectional view of the viscosity measurement apparatus (20). The apparatus (20) shown includes a direct-current motor (22) having a narrow shaft (24) to which a rotatable cylindrical bob (26) is attached. The rotatable bob (26) is mounted directly in the drive shaft of the motor (22) and rotates at the same speed as the motor. The diameter of bob (26) is smaller than the diameter of motor (22).

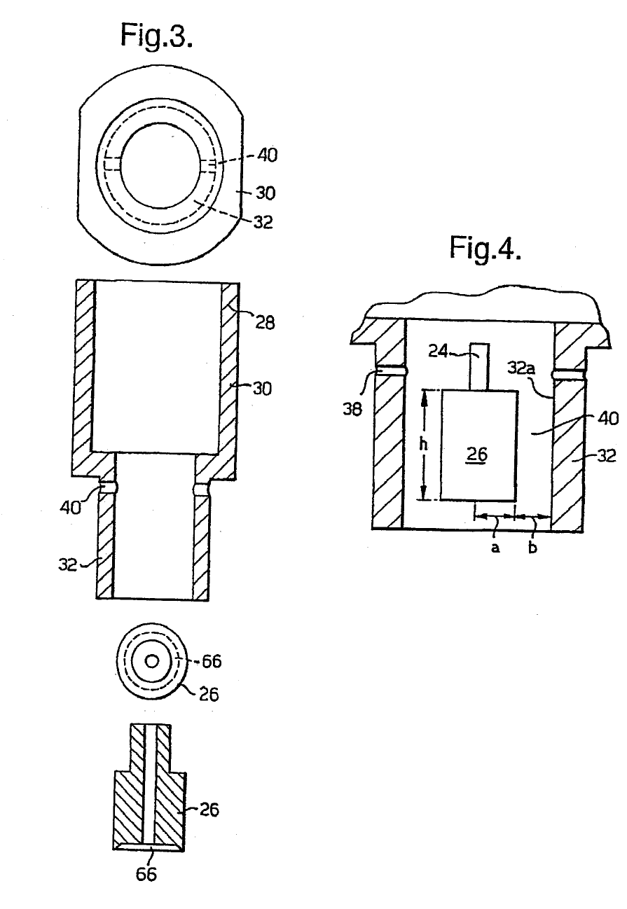

Apparatus (20) also includes a jacket (28) which comprises a hollow circular cylindrical upper portion (30), and a similarly shaped lower portion (32). As the cylinders (30) and (32) are hollow they have inner surfaces (30a) and (32a), respectively, and outer surfaces (30b) and (32b), respectively, The inner diameter of the lower portion (32) of jacket (28) is slightly larger than the diameter of the bob (26), so that a gap (40) is formed between the bob and the lower portion (32) of the jacket. Apparatus (20) having a gap (40) of 0.5 mm between the bob and lower jacket portion (32) is shown in the engineering drawing of FIG. 3.

The upper portion (30) of jacket (28) is dimensioned so as to receive motor (22), and the lower portion (32) of jacket (28) is dimensioned so as to receive bob (26). As the lower portion (32) of the jacket is of a smaller diameter than the upper portion (30), a shoulder (34) is formed where the portions (30) and (32) meet. The inner upper surface (34a) of the shoulder retains the motor (22) in place. The lower surface (34b) of the shoulder enables the lower portion (32) of the jacket (which contains the bob) to be inserted into a well (36) (or other suitable container) containing liquid sample (18), without falling into the well. The lower portion (32) of the jacket has small vents (38) formed therein. These vents (38) are positioned towards the upper part of the lower portion (32) of jacket (28). The lower portion (32) of the jacket also has a thermocouple probe (70) attached thereto, in order to measure the temperature of the liquid sample (18).

During operation of the apparatus (20), the lower portion (32) of the apparatus is inserted into a well (or other container) containing liquid sample (18). The jacket (28) remains stationary while the bob (26) is rotated by the motor (22). The liquid sample (18) under test fills the gap (40) between the bob and the jacket. Vents (38) formed in the lower jacket portion (32) enable air to escape from the gap (40) between the bob (26) and the jacket as the gap fills with liquid.

Viscous drag is imparted on the rotating bob (26) by the fluid sample (18) under test and this acts to slow the motor (22). The more viscous the fluid (i.e., the more resistant the liquid is to flow), the more drag is imparted on the bob, and the more power is required to maintain the bob rotating at a constant speed. The power required to maintain the bob (26) rotating at a constant speed is therefore related to the viscosity of the sample (18).

From standard viscosity measurement theory, it can be shown that the torque M required to rotate bob (26) when it is in contact with a viscous fluid sample (18) is given by:

$$M = \frac{4 π h η}{( \frac{1}{{a}^{2}} - \frac{1}{{\vert a + b \vert}^{2}} )} \qquad ( 1 )$$

where ω is the angular velocity of the bob (26), η is the viscosity of the sample (18), a is the radius of the bob, and b is the size of the gap (40) between the bob and the inner surface of lower jacket portion (32). Dimensions a and b are shown diagrammatically in FIG. 4. The torque, M, generated by the motor (22) is given by:

M=KI (2)

where K is the torque constant of the motor (22), and I is the motor current. Rearranging the terms and solving for I gives:

$$I = \frac{4 π ω h η}{K ( \frac{1}{{a}^{2}} - \frac{1}{{\vert a + b \vert}^{2}} )} . \qquad ( 3 )$$

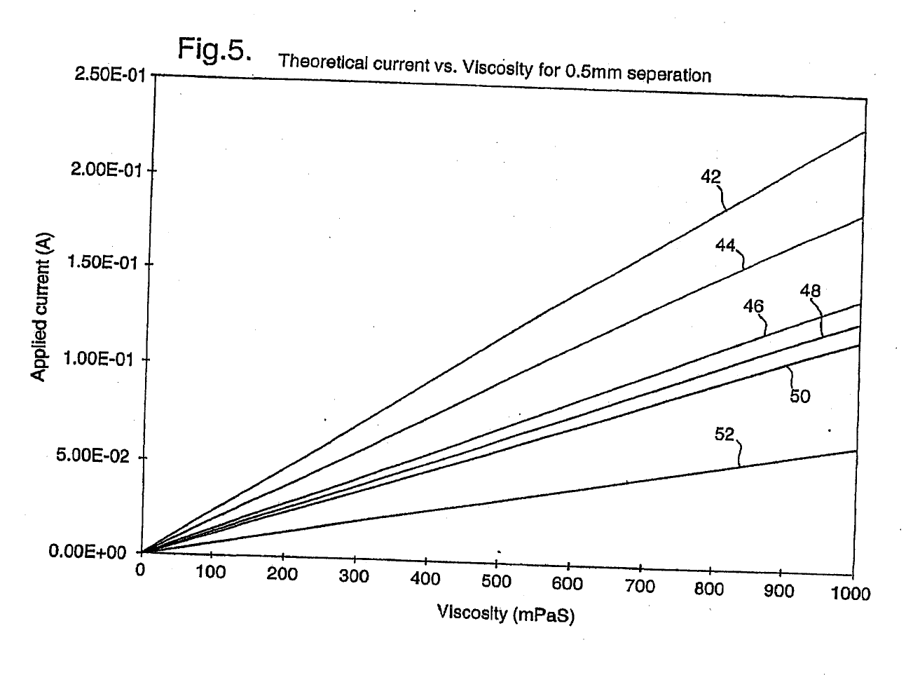

It can be seen that if a motor operates at a constant speed, ω, the current, I, drawn by the motor (22) is directly proportional to the viscosity of the fluid sample (18). This is illustrated by the graph shown in FIG. 5. Results for the following six different motors are shown in the graph: 6V D16 (42), 6V D12 (44), 110045 (Maxon) (46), 12V D12 (48), 12V D16 (50), and 12V D22 (52). The results shown in the graph of FIG. 5 were calculated for a coaxial cylinder separation, b, of 0.5 mm and the bob (26) was rotated at a frequency, f, of 5 Hz (where ω=2πf). The graph shows that the apparatus (20) is able to measure viscosities in the range 1 to 1000 mPas.

The slopes of plots (42) to (52) are proportional to the torque constant, K, of the motor. The magnitude of the torque constant is an important factor when choosing a motor, as it contributes to the resolution of the measurements taken. The motor must be capable of providing the torque necessary to rotate the bob (26) over the desired rotational speed range. The other main parameters which affect the performance of a motor are its physical size, speed control, power output, and the magnitude of the current change with changing load, i.e., the motor must be sensitive enough to detect very small changes or differences in the load. These parameters must be taken into account when choosing a motor for the viscosity measurement apparatus (20). Another aspect of motors which needs to be assessed is the type of direct-current motor which should be used. This will now be discussed.

A commutator motor is one where the rotating section of the motor comprises a coil of wire. The commutator reverses the polarity of the current in the coil as it rotates, so that the force exerted between the magnetic field produced by the coil and the magnetic field generated by external magnets is always in the same direction. However, commutator motors are subject to a “cogging” effect. This effect occurs as the commutator switches the polarity of the current. When the polarity of the current is being switched, the motor is momentarily not being driven and is therefore subject to deceleration due to friction from, for example, the brushes, bearings, and any load on the motor. As the commutator reconnects, the current increases and acceleration of the motor occurs. The inertia of the motor ensures that it continues to turn through the point where it is not being driven, but the cogging effect is more noticeable at low speeds. The multi-commutator design used in high precision motors helps to reduce this effect. Multi-commutator motors are variants of the commutator motor and employ a number of coils. This reduces the “cogging” effect and enables the coils to rotate more smoothly.

A brushless motor comprises multiple coils on the casing of the motor and employs electronic commutation. To rotate the motor requires an external circuit to control a multi-phase alternating current (a.c.) signal. The advantage of this type of motor is that it runs more smoothly and does not lose drive intermittently as occurs with mechanical commutator motors. However, the disadvantage of a brushless motor is that complicated electronics are required to drive it and to measure the current in the motor.

In the viscosity measurement apparatus (20) described herein, the motor (22) will normally be running at a speed significantly lower than the speed it was designed to run at. Therefore a motor with a low starting current, low friction, and a very reproducible character is required. It is for this reason that a precision multi-commutator motor should be used, rather than a standard off-the-shelf motor. An example of a suitable motor is one manufactured by Maxon Motors (part number 110045). The parameters of this motor are shown in the following table:

| Motor Parameter | Value | Units |
|---|---|---|
| Motor Power | 2 | Watts |
| Torque Constant | 9.22E−03 | Nm/A |
| Supply Volts | 12 | V |
| Speed Constant | 1040 | rpm/V |
| No Load Current | 9.50E−03 | A |
| Mechanical Time Constant | 21.8 | ms |
| Rotor Inertia | 0.797 | gcm² |
| Terminal Resistance | 23.1 | Ohms |
| No Load Speed | 12200 | rpm |
| Max Continuous Torque | 2.25E−03 | Nm |
| Stall Torque | 4.78E−03 | Nm |
| Friction Torque | 8.76E−03 | Nm |

Also, in order to control the speed of the bob (26) accurately, a shaft encoder (54) or other such device (such as a tacho generator) is required to provide information about the speed of the bob. A tacho generator is a small direct-current motor run in reverse, i.e., it produces an output voltage that is proportional to its rotational speed. A shaft encoder (54) is a device that produces a fixed number of pulses per revolution, thus as the speed of the motor (22) increases, so does the frequency of the pulses. These devices can either be attached to the motor, or can be built into the motor. For the viscosity measurement apparatus (20) described herein, a magnetic shaft encoder (54) from Maxon Motors (part number 110778) was built into the motor (22).

There are a number of elements which are required to vary and maintain the rotational speed of the motor (22). These are: (1) a controllable power delivery system to the motor; (2) a method of measuring the speed of the motor; and (3) a method of setting the speed of the motor. There are two standard methods of automatically controlling the power supplied to the motor (22). The most efficient and common method is pulse width modulation (PWM). This involves applying a fixed voltage to the motor (22) for a variable period of time. The period of the pulses can vary from a few milliseconds to a continuous d. c. signal. There are a number of problems with this approach. In order to maintain the motor running at low speeds, the pulse widths must be short with a relatively long gap between the pulses. This makes accurate measurement of current difficult. A large capacitor across the motor terminal improves the accuracy of the current measurement, but there will still be variations in observed current, and the capacitor will need to be physically large to obtain the high degree of smoothing required. However, if very low speeds (e.g. less than 400 rpm) are not required, then this method can be used.

The second standard method of automatically controlling a direct-current motor is by use of a proportional controller. Here, a transistor is used to vary the current, I, through the motor (22) in order to achieve the desired speed of rotation, ω, of the bob (26). This is a less efficient method than pulse width modulation, as power is lost in the transistor. However, a constant d. c. current is applied to the motor (22) rather than voltage pulses. This allows for a simple (and accurate) method of measuring the actual motor current, I.

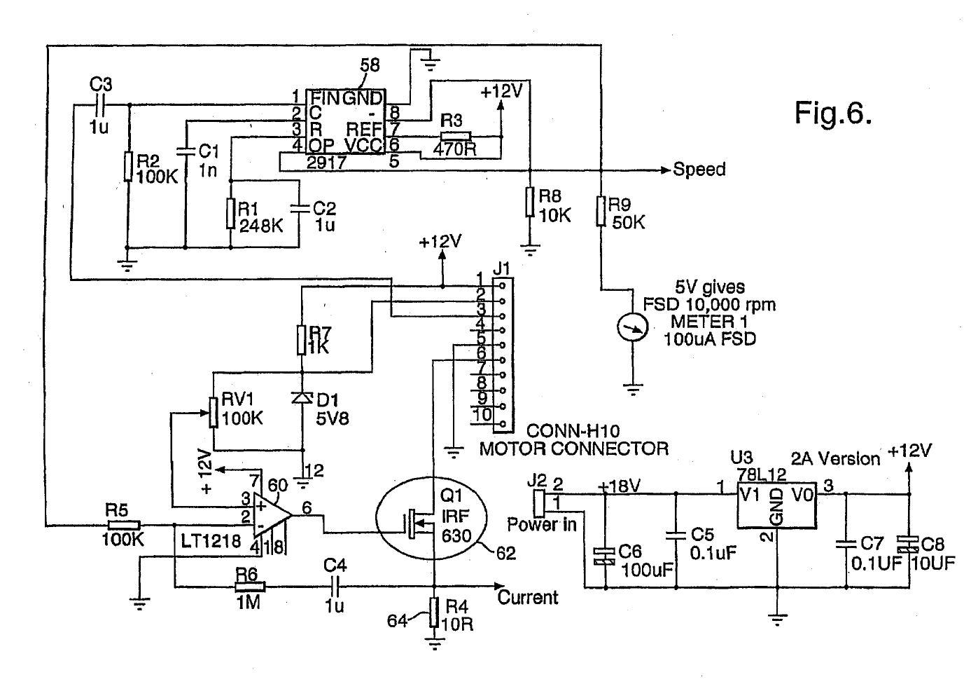

A circuit designed using the proportional control method is shown in FIG. 6. The circuit includes a frequency-to-voltage (F/V) convertor (58) which converts the frequency output of the motor (22) to an analogue voltage in the range 0 to 5 V, representing from 1 to 10,000 revolutions per minute (rpm) of the motor. The circuit has been designed for a 2 W 12V motor from Maxon. Note that each type of motor has its own characteristic frequency response, and use of this circuit with other types of motor may cause instability in the circuit.

The output of the F/V converter (58) is fed to an operational amplifier (60), where it is compared to a set voltage. The set voltage is adjusted by means of a 10-turn potentiometer, and allows the speed of the motor (22) to be varied. The operational amplifier (60) controls a MOSFET (62) which (in this case) acts as a variable resistor. The amplifier (60) modulates the resistance of the MOSFET (62) to allow current to flow through the motor (22), thus adjusting or maintaining its speed. The current flowing through the motor (22) is measured by observing the voltage across a 10 Ohm resistor (64) in series with the motor. There is an integrating element feeding back the current to the amplifier (60), which provides the circuit with stability. Using this circuit, when the speed of the motor (22) is set it should not take more than 1 second for stability to be reached. This value will, of course, depend on the viscosity of the sample (18) under test.

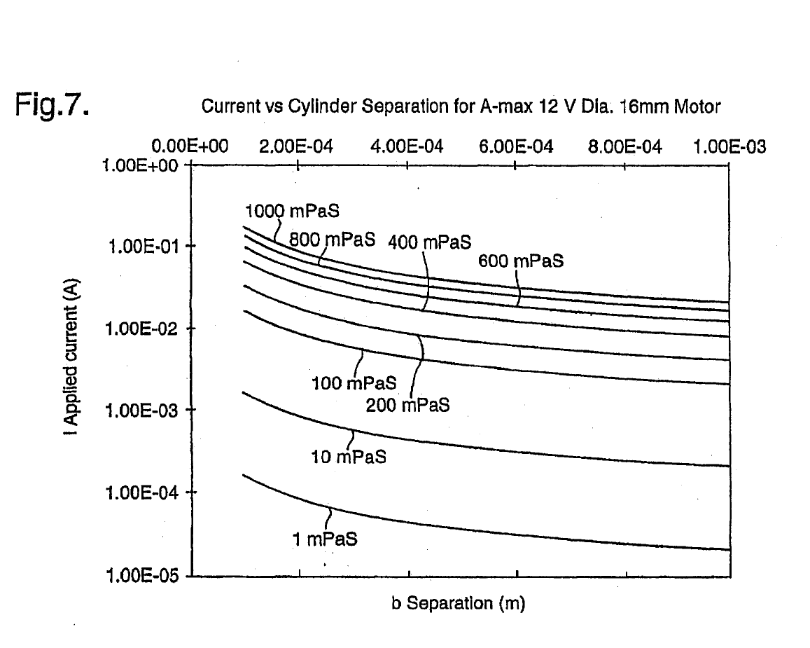

In considering the design of the viscosity measurement system (20), it is important to maximise the load “seen” by the motor (22). This can be achieved i) by maximising the surface area of the bob (26) (i.e., by making it as long and/or as wide as possible), and ii) by minimising the distance, b, between the bob and the lower jacket portion (32). FIG. 7 shows theoretical plots of distance b against current, I, for viscosities ranging from 1 to 1000 mPas. It can be seen that at smaller separations, b, of the bob (26) and the lower jacket portion (32), the resolution of the apparatus (20) is better than at larger values of b. This is because the current, I, is higher and is therefore easier to measure.

It is important that only shear of the liquid in the required area (i.e., in the vicinity of the bob) affects the viscosity measurement. Therefore the diameter of the shaft (24) has to be minimised, as does the interaction of the bottom of the bob (26) with the bottom of the well (36) containing the liquid sample (18). This is achieved by making the distance between the base of the bob (26) and the bottom of the well (36) as large as possible by, for example, having a shallow circular recess (66) in the base of the bob. Ideally the bob (26) will be placed in the well (36) so that the top of the bob is just above the level of the liquid (18). However, if the level of the liquid (18) in the well (36) is too high, or the bob (26) is inserted too far into the liquid so that the shaft (24) is also partially (or completely) immersed in the liquid, a vortex can form above the bob. This will introduce errors into the viscosity measurements. This problem will be exacerbated if the bob (26) is rotated at high speeds. In addition, if the bob is rotated too quickly, air bubbles will form in the fluid sample (18), and this will introduce further errors into the viscosity measurements. The design and dimensions of the jacket (28), the dimensions of the bob (26), and accurate control of the speed of the bob are therefore crucial to the accuracy of the viscosity measurement apparatus (20).

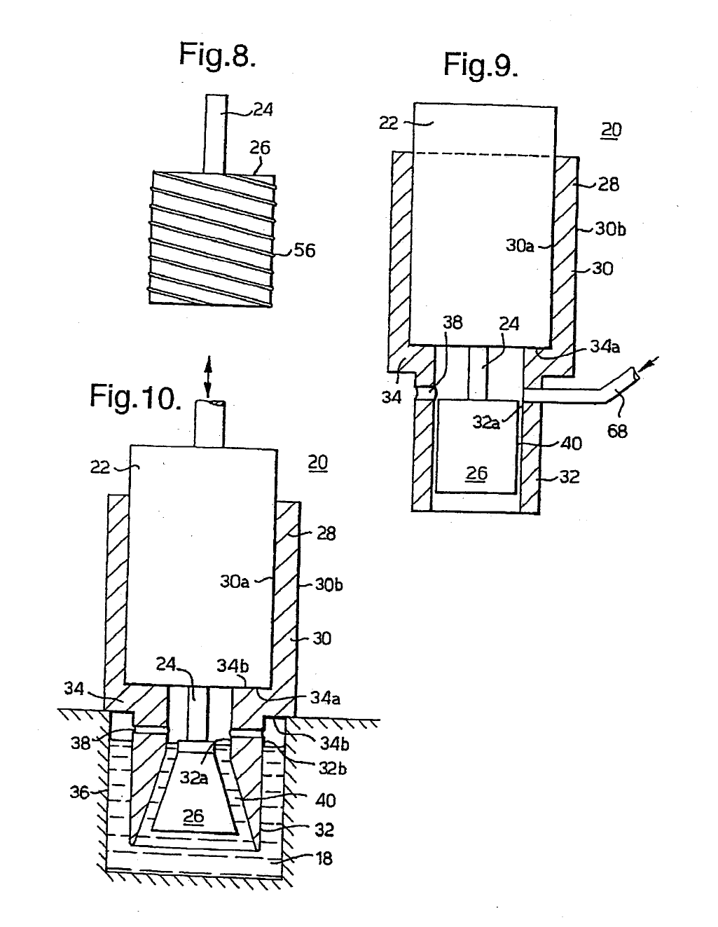

When measuring very high viscosity liquids, the surface tension of the liquid may be very high. This can prevent the liquid sample(s) (18) under test from filling the gap (40) between the bob (26) and the lower jacket portion (32). However, if a spiral (56) (or groove) is formed on the outer surface of the bob (as shown in FIG. 8), this will have the effect of transporting the liquid up the sides of the bob (26), thus filling the gap (40). This works on the same principle as Archimedes' screw. The groove (56) can be machined, having a pitch of the order of 1 mm, the depth and width of the groove being of the order of 0.1 mm.

Cleaning of the apparatus (20) once it has been removed from the liquid requires disassembly of the mechanism. It is, however, possible to modify the apparatus (20) so that it does not have to be disassembled every time it is cleaned. One or more injection nozzles (68) (as shown in FIG. 9) can be provided, such that cleaning fluid can be introduced into the gap (40) between the bob (26) and the lower jacket portion (32). When the apparatus (20) has been removed from the test sample (18), the cleaning fluid is sprayed in to clean the shaft (24), bob (26) and the inner surfaces (32a) of the lower jacket portion (32). It is important that all of the cleaning fluid is removed before the apparatus (20) is reused, as the fluid will affect the viscosity measurements. Thus compressed gas is passed via the injection nozzles (68) into the gap (40) between the bob and the lower jacket portion (32), expelling any residual cleaning fluid, leaving the apparatus (20) ready to be used for another sample (18). The injection nozzles (68) can either be manufactured separately and attached to the apparatus (20), or formed as part of the jaclet (28).

The viscosity measuring apparatus (20) described herein can control the shear rate imparted on a fluid by adjustment of the gap (40) between the bob (26) and lower jacket portion (32), and the angular velocity, ω, of the bob. A variable gap (40) between the bob (26) and the jacket (28) has the beneficial effect of allowing a greater range of shear rates to be obtained. The combination of a bob (26) having tapered sides (as shown in FIG. 10) and a jacket (28) having a lower portion (32) with tapered inner sides (32a), together with a means for raising and lowering the bob allows such a mechanism to be constructed. As shear rate is inversely proportional to the dimensions, b, of gap (40), by raising the bob (26) while keeping the angular velocity of the bob constant and by decreasing the gap, the shear rate may be increased. And by lowering the bob, gap (40) is increased, thereby decreasing the shear rate.

An array of such apparatus (20) may be used in order to measure the viscosity of liquid samples (18) in, for example, a 24 well micro-titre plate of the type commonly used in mass screening. The number of wells may vary between 12 and 96, with sample sizes of 200 microlitres to 5 millitres. Due to size constraints, the largest diameter motor that will fit into a standard 24 well titre plate format is 16 mm. This allows space for 24 motors within the plate. This fact limits the choice of encoder to either a small magnetic or optical system producing 16 pulses per revolution (the larger the number of pulses, the more accurately the motor speed can be measured).

Advantages of the viscosity measurement system (20) described herein are:

measurement of viscosity is relatively simple;

the apparatus is easy to construct;

the apparatus can be used with standard micro-titre plates;

some elements of the apparatus (e.g., the bob and jacket) can be made to be disposable;

standard measurement techniques can be used; and

some components (such as the motor) are commercially available.

Using the viscosity measurement apparatus (20), samples with viscosities in the region of 1 mPas to 1000 mPas can be measured with a resolution of 1 mPas.

Variation may be made to the aforementioned embodiments without departing from the scope of the invention. For example, the apparatus has been designed to mainly analyse Newtonian fluids, but it can also be used to measure the viscosity of non-Newtonian fluids. However, the apparatus must first be calibrated using Newtonian fluids with known characteristics.

1. A system for measuring the viscosity of a liquid sample (18) having a volume between 200 microlitres and 5 millilitres, said system comprising:
i) a least one well (36) for retaining the liquid sample (36)
ii) at least one measurement apparatus (20) comprising;
a substantially cylindrical rotatable body (26);
a retaining means (28) of which at least a portion (32) is adapted to be received into the well (36), said portion (32) including a bore (32a) having a complimentary shape to the rotatable body (26) and in which the rotatable body (26) is disposed coaxially, the bore (32a) and the rotatable body being dimensioned and spaced apart radially so as to form an annular gap (40) extending therebetween to receive, in use, the liquid (18);
drive means (22) for rotating the rotatable body;
control means for controlling the speed of the rotatable body;
current measurement means for measuring the electric current supplied to the drive means;
means for converting the current measurement into a viscosity measurement.

2. A system according to claim l, wherein the rotatable body (26) is frusto-conical in shape.

3. A system according to claim 1 or claim 2, wherein the rotatable body (26) has a spiralled groove (56) formed therein.

4. A system according to any one of claims 1 to 3, further comprising means for raising and lowering the rotatable body (26) whilst it is disposed within the bore (32a).

5. A system according to any one of claims 1 to 4, wherein the retaining means (28) comprises a tubular jacket.

6. A system according to claim 5, wherein said tubular jacket (28) comprises an upper portion (30) and a lower portion (32), said lower portion (32) including the bore (32a).

7. A system according to claim 6 wherein the upper portion (30) is dimensioned to receive the drive means (22).

8. A system according to claim 6 or claim 7, wherein the lower portion (32) is of smaller diameter than the upper portion (30) such that a shoulder (34) is formed where said portions (30,32) meet, said shoulder (34) having an inner upper surface (34a) and a lower surface (34b).

9. A system according to claim 8, wherein the inner upper surface (34a) of the shoulder (34) is dimensioned to retain the drive means (22) and the lower surface (34b) is dimensioned to prevent the upper portion (30) of the tubular jacket from being received into said well (36).

10. A system according to any one of claims 1 to 9, wherein the retaining means (28) has at least one vent (38) to enable the flow of fluid therethrough.

11. A system according to claim 10, further comprising cleaning means for cleaning the apparatus (20), said cleaning means including at least one nozzle (68) connected to the apparatus (20) via at least one vent (38)

12. A system according to any one of claims 1 to 11, wherein the control means comprises a shaft encoder (54).

13. A system according to claim 12, wherein the encoder (54) comprises a magnetic shaft encoder or an optical shaft encoder.

14. A system according to any one of claims 1 to 13, wherein said apparatus (20) further comprises means for raising and lowering the rotatable body (26) within the bore (32a).

15. A system according to any one of claims 1 to 14 further comprising temperature measurement means (70) for measuring the temperature of the fluid.

16. A system according to claim 15, wherein said temperature means (70) comprises either a thermocouple probe or a platinum resistance heater.

17. A system according to any one of claims 1 to 16, comprising between 12 and 96 wells (36).

18. A system according to claim 17, wherein said wells (36) are provided in a micro-titre plate.

19. A system according to any one of claims 1 to 18, comprising a plurality of measurement apparatus (20).

20. A system according to claim 19, wherein the number of wells (36) is equal to the number of measurement apparatus (20).
